(19) United States
(12) Patent Application Publication
(10) Pub. No.: US 2004/0050308 A1
(43) Pub. Date: Mar. 18, 2004

(54) SEEDING SHOVEL SOWING SEEDS ONE BY ONE

(76) Inventor: Ching-Long Wang, Taichung (TW)

Correspondence Address: Ching-Long Wang, 235 Chung-Ho, Box 8-24, Taipei, TW

(21) Appl. No.: 10/233,394

(22) Filed: Sep. 3, 2002

(51) Int. Cl. A01C 5/02

(52) U.S. Cl. 111/95

(57) ABSTRACT

A seeding shovel sowing seeds one by one comprises a body, an adjusting rod buckled to a bottom of the body, and an actuating block for actuating the adjusting rod. A center of the shoveling portion has a slotted track for buckling an adjusting rod. A stopping piece is installed at a predetermined position of the shoveling portion. A bottom of the stopping piece has a through hole. Falling seeds may pass through the though hole. The slotted track has a portion coupled to the through hole. The portion is installed with an outlet. An adjusting rod passes through the portion between the handle and the shoveling portion. The top of the distal end of the adjusting rod is installed with an actuating block. Thereby, the actuating block can drive the adjusting rod to move reciprocally. When the user shovels, seeds are embedded into earth rapidly by one hand.

### BACKGROUND OF THE INVENTION

The present invention relates to shovels, and particularly to a seeding shovel which can sow seeds one by one. By the seeding shovel, when the user shovels, seeds are embedded into earth rapidly by one hand at the time of digging earth.

Prior art shovels have only a function of digging earth. The shovel serves to dig a hole on earth and then seeds are placed into the hole by fingers. Then the hole is flat so as to complete the work of sowing. However, in this prior art operation, the user must dig earth by one hand and sow seeds on the other hand. The operation is inconvenient and necessary to be improved.

### SUMMARY OF THE INVENTION

Accordingly, the object of the present invention is to provide a seeding shovel which can sow seeds one by one. The shovel of the present invention comprises a body, an adjusting rod buckled to a bottom of the body, and an actuating block for actuating the adjusting rod. A center of the shoveling portion has a slotted track for buckling an adjusting rod. A stopping piece is installed at a predetermined position of the shoveling portion. A bottom of the stopping piece has a through hole for being passed by falling seeds. The slotted track is a portion coupled to the through hole. The portion is installed with an outlet. An adjusting rod passes through the portion between the handle and the shoveling portion. The top of the distal end of the adjusting rod is installed with an actuating block. Thereby, the actuating block can drive the adjusting rod to move reciprocally. When the user shovels, seeds are embedded into earth rapidly by one hand.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is a cross section view of the present invention.

FIG. 4A shows one embodiment of the present invention where the seeding shovel is being used to shovel objects.

FIG. 4B is a plane view showing one embodiment of the present invention where the seeding shovel is in a status of before shoveling.

FIG. 4C is a plane view showing one embodiment of the present invention wherein the seeding shovel is in a statue of after shoveling.

FIG. 4D shows one embodiment showing that the seeding shovel of the present invention is used to flat earth.

### DETAILED DESCRIPTION OF THE PREFERRED EMBODIMENTS

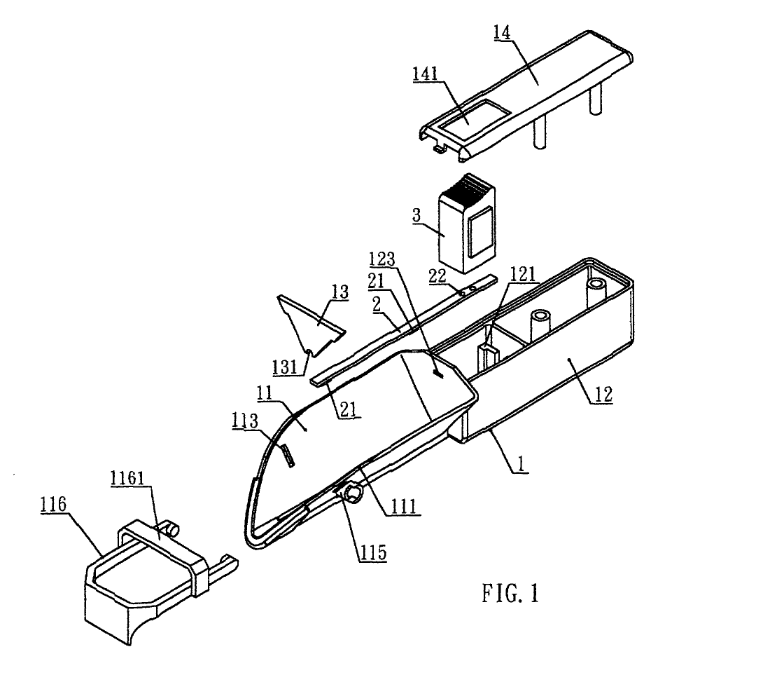

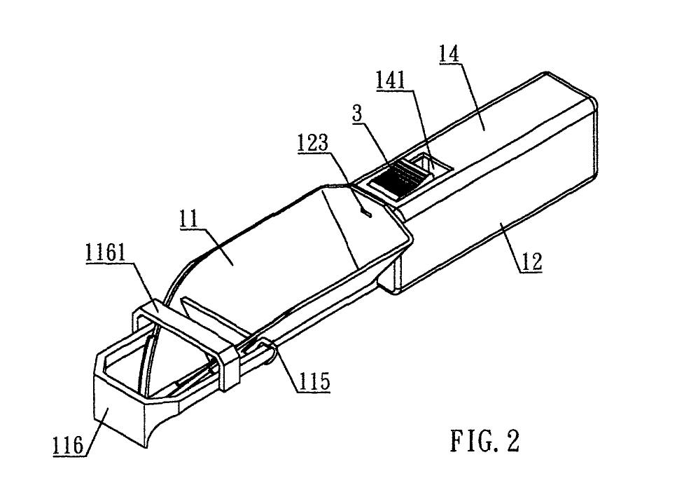

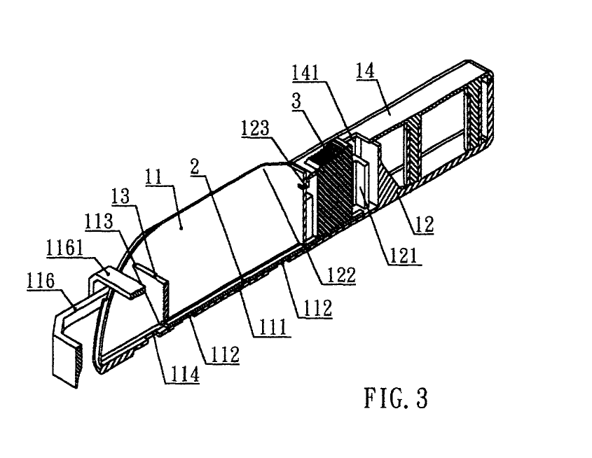

Referring to FIGS. 1 to 3, seeding shovel sowing seeds one by one of the present invention is illustrated. The seeding shovel includes a body 1, an adjusting rod 2 buckled to a bottom of the body 1, and an actuating block 3 for actuating the adjusting rod 2.

The body 1 includes a front shoveling portion 11, and a rear handle 12. Two sides of the shoveling portion 11 are inclined upwards. A center of the shoveling portion 11 is formed with a slender horizontal portion 111. A slotted track 112 is installed on the horizontal portion 111. Thereby, the adjusting rod 2 is movable on the slotted track 112. Two sides of the shoveling portion 11 have embedding holes 113 at predetermined positions for resisting against a stopping piece 13 running across the shoveling portion 11. A bottom of the stopping piece 13 is installed with a through hole 131 for placing falling seeds. A portion of the slotted track 112 on the bottom of the shoveling portion 11 coupling to the stopping piece 13 is installed with an outlet 114. Thereby, when the adjusting rod 2 moves, the seed falls to earth from the outlet 114 exactly.

Two sides of the shoveling portion 11 have pivotal shafts 115. Each pivotal shaft 115 is pivotally installed with an earth poking harrow 116 which has a U shape and is protruded from a front end of the shoveling portion 11. The earth poking harrow can be lifted around a center of the pivotal shaft 115. Thereby, a front end of the shoveling portion 11 can be inserted into earth successfully. An upper press level 1161 is protruded from a middle section of the earth poking harrow 116. The fingers of the user can press the upper press level 1161 in advance. Thereby, earth is moved into a hole by the earth poking harrow 116.

The handle 12 is hollowed. A stopping rib 121 for confining a reciprocal moving actuating block 3 is installed in the handle 12. At the connection of the handle 12 and the shoveling portion 11 has a penetrating hole 122 for passing through the adjusting rod 2. A buckling groove 123 is formed at a predetermined position above the penetrating hole 122. After the adjusting rod 2 and the actuating block 3 are placed in the shoveling portion 11, an upper cover 14 can cover the buckling groove 123. A portion at a top of the upper cover 14 coupling to the actuating block 3 is installed with a via hole 141 larger than the actuating block 3.

The adjusting rod 2 passes through the penetrating hole 122 at the connection of the shoveling portion 11 and the handle 12. A portion at a lower end of the adjusting rod 2 corresponding to the slotted track 112 of the shoveling portion 11 are sequentially installed with a buckling block 21 capable of being buckled to the slotted track 112. The area of the adjusting rod 2 is slight smaller than the slotted track 112 so that the adjusting rod 2 may move reciprocally in the slotted track 112. A distal end of the adjusting rod 2 is further installed with a positioning hole 22. The actuating block 3 is exactly locked the positioning hole 22.

The actuating block 3 is locked above the adjusting rod 2. A top of the actuating block 3 slightly protrudes from the top end of the via hole 141 of the upper cover 14. The area of the actuating block 3 is smaller than the via hole 141 and thus the actuating block 3 is movable reciprocally in the via hole 141.

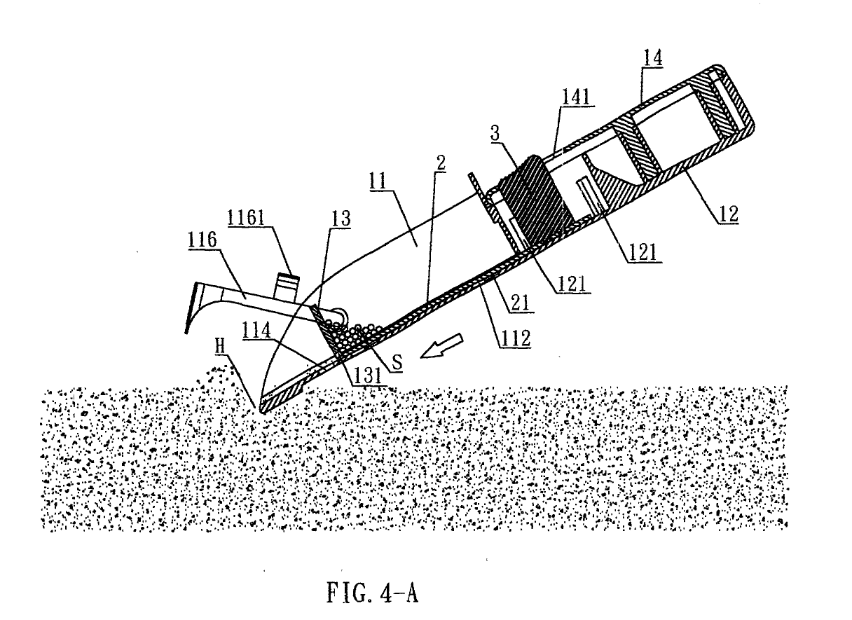

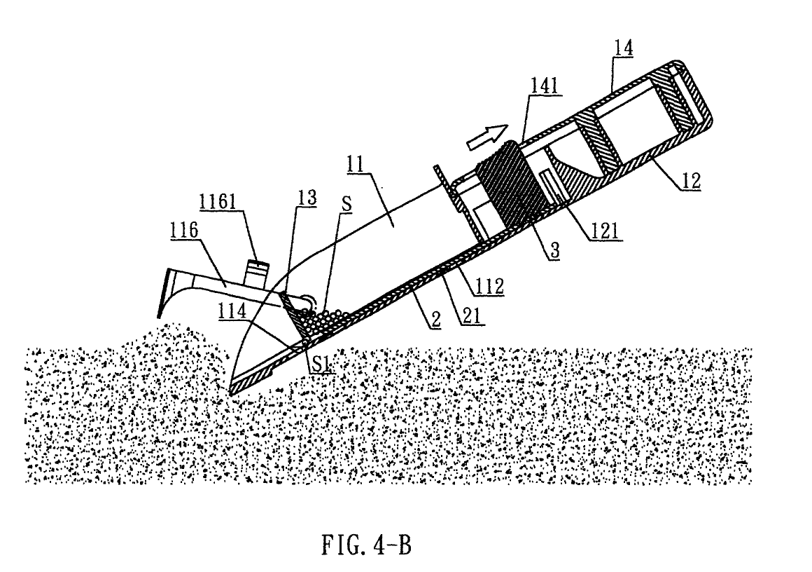

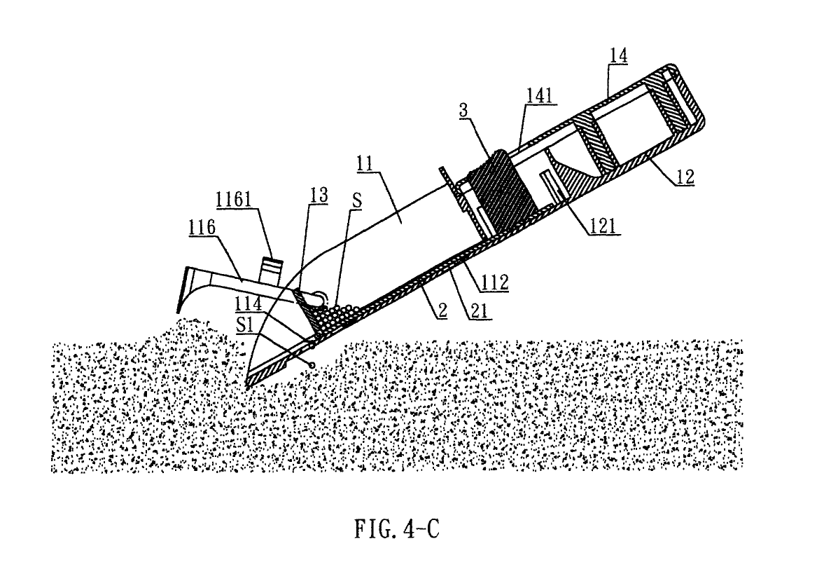

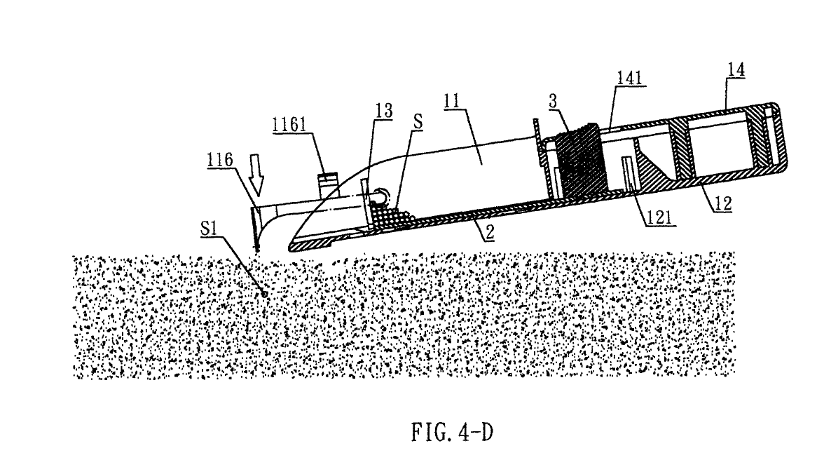

The operation of the present invention is illustrated in FIG. 5. At first, the shoveling portion 11 of the body 1 is placed with a plurality of seeds. The earth poking harrow of the seeding shovel are lifted in advance so that the shoveling portion 11 can be inserted into the shoveling portion 11 and thus it can shovel earth upwards. A hole H for placing the seeds is formed in the earth (referring to FIG. 4A). Then, the actuating block 3 may drive the adjusting rod 2 to move between the handle 12 and the shoveling portion 11. Thereby, when the actuating block 3 moves, the adjusting rod 2 is driven to move backwards. A space for receiving falling seeds is exactly formed between a bottom of the shoveling portion 11 and the through hole 131 of the stopping piece 13 (referring to FIG. 4B). Then, the actuating block 3 is twisted forwards so that the actuating block 3 exactly pushes the seed S1 at a lower end of the stopping piece 13 to move forwards. Thereby, the seed falls into the hole H along the outlet 114 (referring to FIG. 4C). Then a finger presses the upper press level 1161 of the earth poking harrow 116 so that the earth at a front end of the hole H can be pushed into the hole H so as to flat the hole H. Thus seeds can be embedded into the earth (referring to FIG. 4D)

Thereby, at the time of shoveling earth, seeds can be embedded into earth rapidly by only one hand.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A seeding shovel sowing seeds one by one comprising a body, an adjusting rod buckled to a bottom of the body, and an actuating block for actuating the adjusting rod; wherein
the body includes a front shoveling portion, and a rear handle; two sides of the shoveling portion are inclined upwards; a center of the shoveling portion is formed with a slender horizontal portion; a slotted track are installed on the horizontal portion; two sides of the shoveling portion have embedding holes at predetermined positions for resisting against a stopping piece running across the shoveling portion; a bottom of the stopping piece is installed with a through hole for placing falling seeds; a portion of the slotted track on a bottom of the shoveling portion coupling to the stopping piece is formed with an outlet; thereby, when the adjusting rod moves, the seed falls into earth from the outlet exactly;
the handle is hollowed and has a stopping rib for confining a reciprocal moving actuating block; at a connection of the handle and the shoveling portion has a penetrating hole for passing through the adjusting rod; a buckling groove is formed at a predetermined position above the penetrating hole; after the adjusting rod and the actuating block are placed in the shoveling portion, an upper cover covers the buckling groove; a portion at a top of the upper cover coupling to the actuating block is installed with a via hole;
the adjusting rod passes through the penetrating hole at the connection of the shoveling portion and the handle; a portion at a lower end of the adjusting rod corresponding to the slotted track of the shoveling portion are sequentially installed with a buckling block capable of being buckled to the slotted track; an area of the adjusting rod is slight smaller than the slotted track so that the adjusting rod moves reciprocally in the slotted track; and
the actuating block is locked above a distal end of the adjusting rod; a top of the actuating block slightly protrudes from a top end of the via hole of the upper cover; an area of the actuating block is smaller than the via hole and thus the actuating block is movable reciprocally in the via hole;
thereby, when the user shovels, seeds are embedded into earth rapidly by one hand.

2. The seeding shovel sowing seeds one by one as claim in claim 1, wherein two front sides of the shoveling portion have pivotal shafts; each pivotal shaft is pivotally installed with an earth poking harrow which has a U shape and is protruded from a front end of the shoveling portion; the earth poking harrow is lifted around a center of the pivotal shaft; thereby, a front end of the shoveling portion is inserted into earth successfully; an upper press level is protruded from a middle section of the earth poking harrow; thereby, the fingers of a user can press the upper press level in advance so that earth is moved into a hole by the earth poking harrow.

3. The seeding shovel sowing seeds one by one as claim in claim 2, wherein the sizes of the through holes at bottoms of the stopping pieces at two sides of the shoveling portion of the body is adjustable.
